(19) United States
(12) Patent Application Publication
(10) Pub. No.: US 2022/0188225 A1
(43) Pub. Date: Jun. 16, 2022

(54) LOW-COST ADDRESS MAPPING FOR STORAGE DEVICES WITH BUILT-IN TRANSPARENT COMPRESSION

(71) Applicant: ScaleFlux, Inc., San Jose, CA (US)

(72) Inventors: Jiangpeng Li, San Jose, CA (US); Qi Wu, San Jose, CA (US)

(21) Appl. No.: 17/120,386

(22) Filed: Dec. 14, 2020

(51) Int. Cl. G06F 12/06; G06F 7/08; G06F 3/06; G06F 11/07

(52) U.S. Cl. CPC G06F 12/0638; G06F 7/08; G06F 3/064; G06F 2212/251; G06F 3/0673; G06F 11/079; G06F 11/073; G06F 3/0604

(57) ABSTRACT

An infrastructure for mapping between logic block addresses (LBAs) and physical block addresses (PBAs). A disclosed method includes: receiving a request the specifies an LBA; determining an applicable zone based on the LBA from a set of zones, wherein the set of zones expose an LBA address space of the storage device; identifying at least one tree from a set of trees having a root node associated with the applicable zone; traversing the at least one tree to identify a set of leaf nodes based on the LBA, wherein each leaf node points to an mpage; and determining corresponding PBA information for the LBA by examining mapping information contained in each mpage.

### TECHNICAL FIELD

The present invention relates to the field of computational storage, and particularly to implementing address mapping for solid-state storage devices with built-in transparent compression.

### BACKGROUND

Solid-state data storage devices, which use non-volatile NAND flash memory technology, are being pervasively deployed in various computing and storage systems. In addition to one or multiple NAND flash memory chips, each solid-state data storage device must contain a controller that manages all the NAND flash memory chips. Within each NAND flash memory chip, all the memory cells are organized in an array→block→page hierarchy, where one NAND flash memory array is partitioned into a large number (e.g., thousands) of blocks, and each block contains a certain number (e.g., 256) of pages. The size of each flash memory page is typically 16 kB or 32 kB, and the size of each flash memory block is typically tens of MBs. Data are programmed and fetched in the unit of page. However, flash memory cells must be erased before being re-programmed, and the erase operation is carried out in the unit of block (i.e., all the pages within the same block must be erased at the same time). As a result, NAND flash memory cannot support the convenient in-place data update.

To embrace the lack of the update-in-place feature of NAND flash memory, solid-state data storage devices must use indirect address mapping. Internally, solid-state data storage devices manage data storage on NAND flash memory chips in the unit of constant-size (e.g., 2 k-byte or 4 k-byte) physical sector. Each physical sector is assigned with one unique physical block address (PBA). Instead of directly exposing the PBAs to external hosts, solid-state data storage devices expose an array of logical block address (LBA) and internally manage/maintain an injective mapping between LBA and PBA. The software component responsible for managing the LBA-PBA map is called flash translation layer (FTL).

Lossless data compression is the most effective means to reduce the data storage cost. One could incorporate lossless data compression function into solid-state data storage devices, being transparent to the host. By deploying solid-state storage devices with built-in transparent compression, host servers can conveniently benefit from lower physical storage cost, without consuming host CPU cycles for compression computation/management. Nevertheless, the implementation of solid-state storage devices with built-in transparent compression is non-trivial. In particular, the runtime compression ratio variation makes it a big challenge to implement the storage device FTL that can ensure very high-speed address mapping without sacrificing the storage reliability/stability and consuming too much computing/memory resource inside storage devices.

### SUMMARY

Accordingly, embodiments of the present disclosure are directed to a system and method for implementing address mapping in solid-state storage devices with built-in transparent compression.

A first aspect of the disclosure provides a solid state storage device, comprising: a compression system that compresses and decompresses data stored in the storage device; and a controller that utilizes a three tiered logical block address (LBA)/physical block address (PBA) map to map between logical storage and physical storage, wherein the LBA/PBA map includes: a zone layer having a set of zones that expose an LBA address space of the storage device, wherein each zone spans a contiguous region of LBA addresses; a routing layer having a set of trees, wherein each tree is indexed by an LBA address and includes a root node and a set of leaf nodes, wherein each root node is associated with a zone from the zone layer, and each leaf node includes a pointer; and an mpage layer that includes a set of mpages, each mpage pointed to by a pointer from the routing layer, wherein each mpage contains LBA/PBA mapping information for LBAs within a contiguous range of LBAs.

A second aspect of the disclosure provides a method, implemented on a solid state storage device, for mapping between logic block addresses (LBAs) and physical block addresses (PBAs), comprising: receiving a request the specifies an LBA; determining an applicable zone based on the LBA from a set of zones, wherein the set of zones expose an LBA address space of the storage device; identifying at least one tree from a set of trees having a root node associated with the applicable zone; traversing the at least one tree to identify a set of leaf nodes based on the LBA, wherein each leaf node points to an mpage; and determining corresponding PBA information for the LBA by examining mapping information contained in each mpage.

### BRIEF DESCRIPTION OF THE DRAWINGS

The numerous advantages of the present disclosure may be better understood by those skilled in the art by reference to the accompanying figures.

FIG. 1 depicts a storage infrastructure in accordance with embodiments.

FIG. 2 illustrates a tiered address map for solid-state data storage devices with built-in transparent compression in accordance with embodiments.

FIG. 3 illustrates the structure of an mpage in accordance with embodiments.

FIG. 4 illustrates the structure of a map-entry in accordance with embodiments.

FIG. 5 illustrates the flow diagram of serving a read request in accordance with embodiments.

FIG. 6 illustrates the flow diagram of serving a write request in accordance with embodiments.

FIG. 7 illustrates the concatenation of two contiguous map-entries into one map-entry in accordance with embodiments.

FIG. 8 illustrates the flow diagram of serving a trim request in accordance with embodiments.

FIG. 9 illustrates the flow diagram of mpage garbage collection in accordance with embodiments.

FIG. 10 illustrates the flow diagram of mpage split in accordance with embodiments.

FIG. 11 illustrates the structure of storing both address map data and “summary” meta-page in NAND flash memory in accordance with embodiments.

FIG. 12 illustrates the flow diagram of reconstructing the address map after power failure in accordance with embodiments.

### DETAILED DESCRIPTION

Reference will now be made in detail to embodiments of the disclosure, examples of which are illustrated in the accompanying drawings.

The core of an FTL is to maintain the logical-physical mapping between the LBA logical storage address space and physical storage address space. In current practice, each LBA address associates with a 4 KB data block, and correspondingly the physical storage space inside storage devices is partitioned into 4 KB blocks, each one associates with a unique PBA address. For conventional storage devices without built-in transparent compression, the 4 KB data block at one LBA address always entirely occupies the 4 KB space at one PBA address. Therefore, storage devices without built-in transparent compression conveniently use a flat LBA-PBA map in which each LBA address has its own unique map entry that records its corresponding PBA address.

Recall that NAND flash memory does not support in-place data update. Given one entry {Lᵢ, Pᵢ} in the LBA-PBA map, in order to update the data block at the LBA Lᵢ, we must write the new data block at another PBA Pⱼ. As a result, we must accordingly update the LBA-PBA map entry from {Lᵢ, Pᵢ} to {Lᵢ, Pⱼ}. Therefore, the LBA-PBA map keeps changing as users keep writing/updating data on storage devices. To improve the data access speed performance, storage devices always try to keep the flat LBA-PBA map entirely in low-latency memory (e.g., DRAM). Therefore, in the case of normal storage devices, the memory resource usage is proportional to the total number of LBA addresses that are exposed by storage devices.

In the context of storage devices with built-in transparent compression, the 4 KB data block Dᵢ at each LBA address is compressed to a data block Cᵢ whose size can be (much) smaller than 4 KB. Meanwhile, each PBA address always associates with a fixed 4 KB physical storage space inside storage devices. As a result, multiple compressed blocks Cᵢ's could share the same PBA, and one compressed block Cᵢ could span over two adjacent PBAs. Let N_{P} denote the total number of PBA addresses (corresponding to the fixed physical NAND flash memory storage capacity insides storage devices), and let N_{L} denote the total number of LBA addresses being exposed/supported by storage devices. In order to fully leverage transparent compression to improve effective storage capacity, we should have N_{L} sufficiently larger (e.g., 2× or 4×) than N_{P}, especially in the presence of highly compressible user data.

As a result, if storage devices with built-in transparent compression use the conventional flat LBA-PBA map (i.e., each LBA address has its own map entry to hold its corresponding physical storage location), the address map will have a very large size and hence demand a large amount of memory resource. This will lead to a higher cost and higher energy consumption. Meanwhile, due to the runtime compression ratio variation, not all the N_{L} LBA addresses being exposed by the storage device could be always utilized by the host. As a result, the conventional flat LBA-PBA address map can be very inefficient for storage devices with built-in transparent compression.

Embodiments provided herein present a method to implement a low-cost logical-physical address mapping strategy that can reduce the memory usage for storage devices with built-in transparent compression.

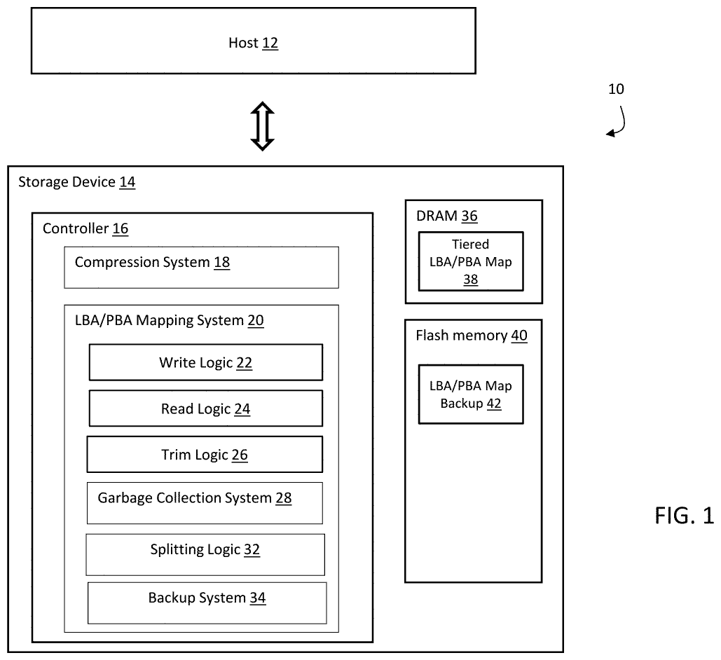

FIG. 1 depicts a storage infrastructure 10 that generally includes a host 12 and a storage device 14. Storage device 14 include a controller 16 (e.g., an FTL) for handling requests from the host, a small amount of DRAM 36, and NAND or flash memory 40 for storing data. The controller 16 includes a compression system 18 for providing built-in transparent compression, i.e. for compressing and decompressing data stored in flash memory 40 and an LBA/PBA mapping system 20. As described in further detail, mapping system 20 utilizes a tiered LBA/PBA map 38 that is stored in DRAM 38, which is also stored as an LBA/PBA map backup 42 in flash memory 40 in the event of a power failure.

Mapping system 20 generally includes write logic for writing data to memory 40, read logic for reading data from memory 40, trim logic 26 the works along with garbage collection system 28 to manage flash memory usage, splitting logic 32 that splits data storage units (i.e., mpages described herein), and a backup system 24 that stores the map 38 into flash memory 40.

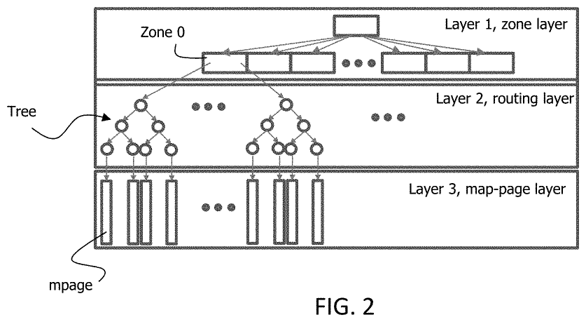

FIG. 2 shows the structure of an illustrative tiered LBA/PBA map 38, which consists of three layers:
1. Zone Layer: The top layer is called the zone layer. Let the set L denote the entire LBA address space being exposed by storage devices with built-in transparent compression. In the zone layer, we partition L into a number of non-overlapped zones (denoted as Lᵢ), e.g., Zone 0. Each zone Lᵢ spans over a contiguous region of LBA addresses, and all the zones contain the same number of LBA addresses. Each zone serves as the root of a routing tree, indexed by LBA.
2. Routing layer: The middle layer is called the routing layer. Let N_{zone} denote the number of zones in the top zone layer. Accordingly, the routing layer contains N_{zone} trees, denoted as Tᵢ(1≤i≤N_{zone}). The root of each tree Tᵢ is one zone in the top zone layer, as shown in FIG. 1. Different tree data structures (e.g., red-black tree, B+ tree, etc.) can be used to implement each routing tree Tᵢ. All the trees in the routing layer are indexed by the LBA address. The leaf nodes in a tree Tᵢ contain a number of pointers, each one points to one map-page (mpage) in the bottom map-page layer.
3. Map-Page layer: The bottom layer is called the map-page layer that contains a large number of map-pages (mpages). All the mpages have the same size (e.g., 2 KB or 4 KB), and each mpage contains the logical-physical address mapping information for LBAs within a contiguous LBA region. LBA ranges of any two mpages do not overlap. Since not all LBAs are used by the host to store data, each mpage only contains the mapping information for the LBAs that indeed store data.

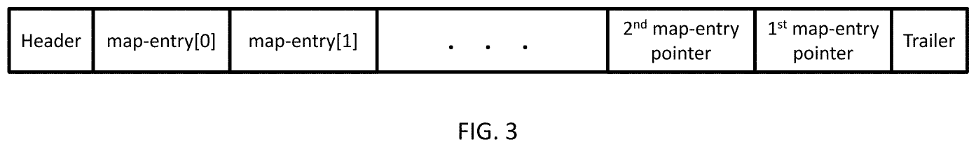

FIG. 3 shows the structure of one mpage, which consists of four parts:
1) Header: The header has a fixed size and keeps information such as the LBA range covered by this mpage and the size of free space inside this mpage;
2) Trailer: At end of each mpage, there is a fixed-size trailer that contains information such as mpage checksum;
3) Map-entries: Each mpage contains one or multiple map-entries, each map-entry holds the information about the physical location of one or multiple contiguous LBAs. All the map-entries are placed from the front to the end within each mpage;
4) Map-entry pointers: Each mpage contains one or multiple map-entry pointers, each pointer points to one map-entry within the same mpage. Each pointer also contains the leading LBA of the contiguous LBAs in its associated map-entry, and all the map-entry pointers are sorted based their leading LBAs.
   Each map-entry holds the physical location information of one or multiple contiguous LBAs that are stored contiguously in the physical storage space. Let n denote the number of contiguous LBAs in a map-entry, and let L_{first} denote the first (i.e., leading) LBA. Hence all the n contiguous LBAs are {L_{first}, L_{first}+1, L_{first}+2, . . . , L_{first}+n−1}. The 4 KB data block at each LBA address is compressed individually, i.e., for each 4 KB data block Dᵢ at the LBA address L_{first}+i, it is compressed to a block Cᵢ whose size can be (much) less than 4 KB. All the n compressed blocks {C₀, C₁, C₂, . . . , Cₙ₋₁} are stored over a contiguous physical storage space inside the storage device. In particular, each map-entry contains the following specific information: (1) the value of n, (2) the leading LBA L_{first}, (3) the size of each Cᵢ, (4) the location of C₀ in the physical storage space. Since all the n compressed blocks {C₀, C₁, C₂, . . . , Cₙ₋₁} are stored over a contiguous physical storage space, the physical location of C₀ and the size of all the Cᵢ's are sufficient to derive the physical location of any compressed block Cᵢ. To maximize the physical storage space utilization efficiency, C₀ is not necessarily aligned with the 4 KB boundary of PBAs, i.e., the first byte of C₀ may be at any position inside the 4 KB at one PBA address.

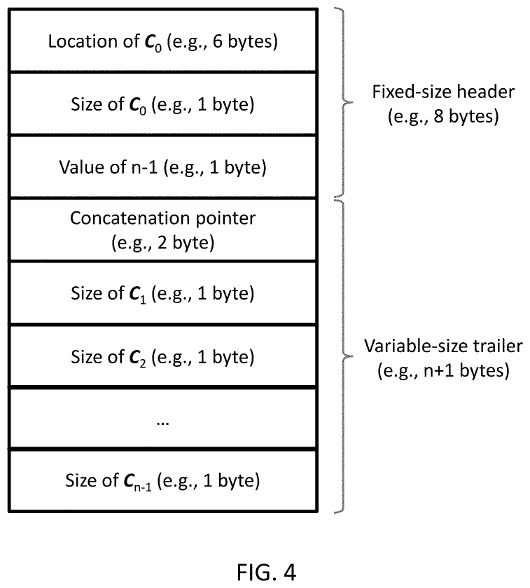

FIG. 4 illustrates one possible structure of one map-entry, which contains two portions: (1) a fixed-size header, and (2) a variable-size trailer. The fixed-size header contains (a) the physical location (i.e., the PBA address and the off-set inside the PBA) of the first byte of C₀, which is represented with a fixed number of bytes (e.g., 6 bytes), (b) the size of C₀ (i.e., the size of the compressed data block of the leading LBA L_{first}), which is represented with a fixed number of bytes (e.g., 1 byte), and (c) the value of n−1 (i.e., the total number of contiguous LBAs covered by this map-entry minus 1), which is represented with a fixed number of bytes (e.g., 1 byte). If a current map-entry covers only a single LBA (i.e., n=1), it will not contain a variable-size trailer (i.e., the size of the trailer is zero). If current map-entry spans over n>1 LBA, then the header will be followed by a variable-size trailer that records the size of the remaining n−1 Cᵢ's for 0<i<n.

Since all the compressed blocks Cᵢ's are stored contiguously over the physical storage space, knowing the position of C₀ and the size of all the Cᵢ's are sufficient to locate and access any compressed block Cᵢ. As shown in FIG. 3, the variable-size trailer starts with a fixed-size (e.g., 2 bytes) concatenation pointer, which is used to merge (or concatenate) multiple map-entries together and will be discussed later in details. Following the fixed-size concatenation pointer are the size of all the remaining n−1 Cᵢ's for 0<i<n. The size of each Cᵢ is represented with a fixed number of bytes (e.g., 1 byte). Suppose the concatenation pointer is 2-byte and the size of each Cᵢ is 1-byte, then the trailer occupies (n+1) bytes in total.

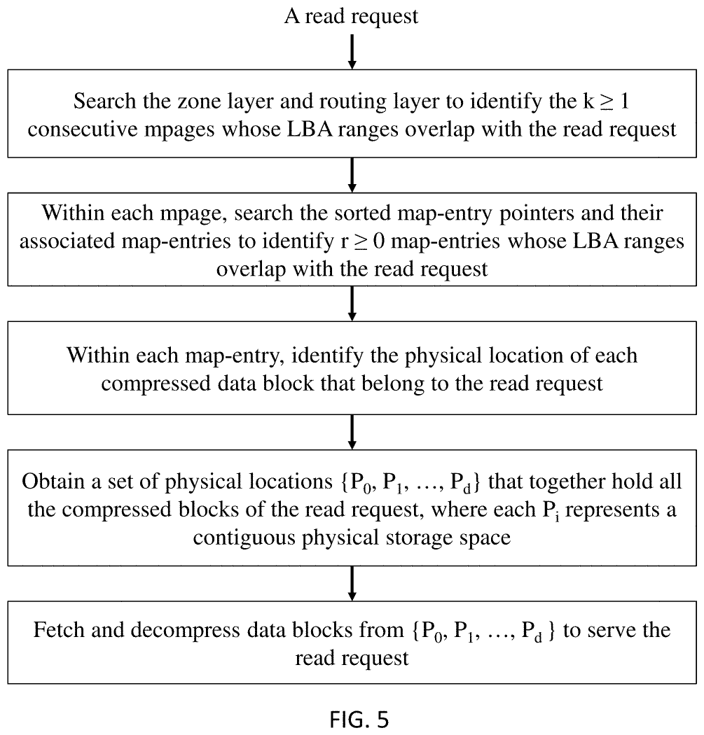

FIG. 5 illustrates the flow diagram of read request logic when using the tiered address map 38. Let L₀ denote the leading LBA of the read request, and let m denote the number of contiguous LBAs in the read request (i.e., the read request covers m LBAs {L₀, L₀+1, L₀+2, . . . , L₀+m−1}). Upon receiving the read request, storage devices first search the zone layer and routing layer to identify the k≥1 consecutive mpages whose LBA ranges overlap with the read request. For each mpage within the k consecutive mpages, we search the sorted map-entry pointers and their associated map-entries to identify r≥0 map-entries whose LBA ranges overlap with the read request. Accordingly, we search through each map-entry within the r map-entries to identify the physical location of each compressed data block that belong to the read request. After searching through all the related map-entries, we obtain a set of physical locations {P₀, P₁, . . . , P_{d}} that together hold all the compressed blocks of the read request, where each Pᵢ represents a contiguous physical storage space. Finally, storage devices fetch and decompress data blocks from {P₀, P₁, . . . , P_{d}} to serve the read request.

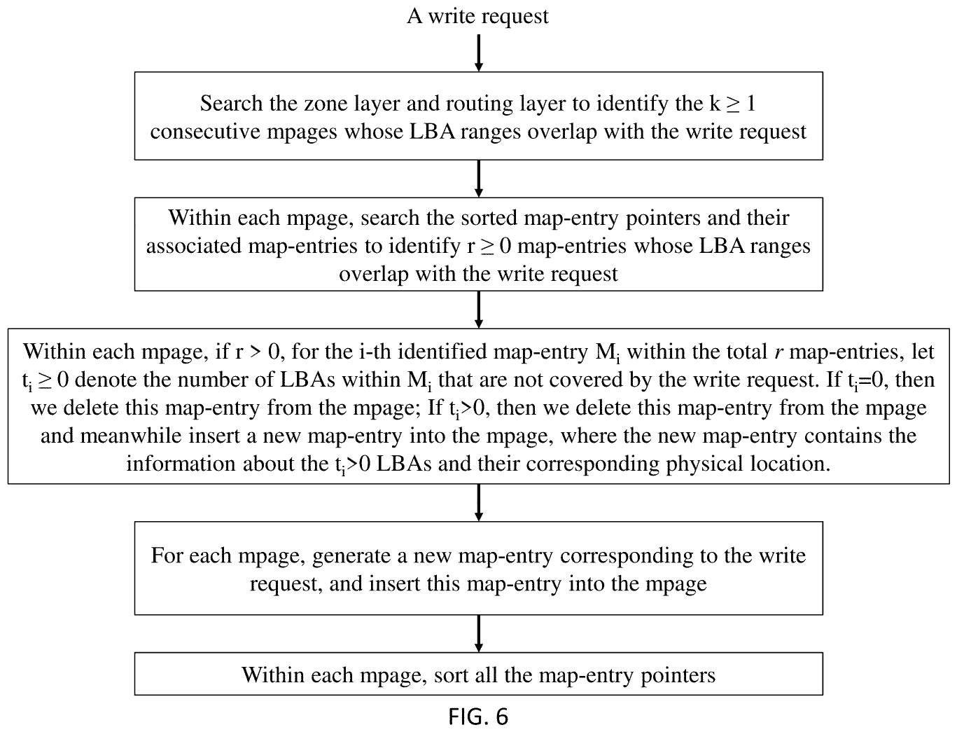

FIG. 6 illustrates a flow diagram of write request logic when using the tiered address map 38. Let L₀ denote the leading LBA of the write request, and let m denote the number of contiguous LBAs in the write request (i.e., the write request covers m LBAs {L₀, L₀+1, L₀+2, . . . , L₀+m−1}). Upon receiving the write request, storage devices first search the zone layer and routing layer to identify the k≥1 consecutive mpages whose LBA ranges overlap with the write request. For each mpage within the k consecutive mpages, we perform the following operations:
1. Search the sorted map-entry pointers and their associated map-entries to identify r≥0 map-entries whose LBA ranges overlap with the write request.
2. If r>0, let {M₁, M₂, . . . , Mᵣ} denote these r map-entries. For each Mᵢ, let tᵢ≥0 denote the number of LBAs within Mᵢ that are not covered by the write request.
   a. If tᵢ=0, then we delete this map-entry from the mpage. To reduce the operational complexity, we only remove its map-entry pointer, and rely on intra-mpage garbage collection (to be discussed later) to reclaim the space occupied by the deleted map-entry within the mpage.
   b. If tᵢ>0, then we delete this map-entry from the mpage and meanwhile insert a new map-entry into the mpage. The new map-entry contains the information about the tᵢ>0 LBAs and their corresponding physical location.
3. Generate a new map-entry corresponding to the write request, and insert this map-entry into the mpage
4. Sort the map-entry pointers in the mpage.
   Let Eⱼ denote a new map-entry that is to be inserted into an mpage, and let Lⱼ denote the contiguous LBA space covered by Eⱼ and Pⱼ denote the contiguous physical space covered by Eⱼ. If Eⱼ is contiguous to an existing valid map-entry (denoted as Eᵢ) in the mpage (i.e., let Lᵢ and Pᵢ denote the contiguous LBA and physical space covered by Eᵢ, we have that {Lᵢ, Lⱼ} and {Pᵢ, Pⱼ)} form contiguous LBA and physical space), then we can merge (or concatenate) Eᵢ with Eⱼ as follows (as shown in FIG. 6): Let w denote the number of contiguous LBAs covered by Eⱼ, and Cᵢ, (0≤i≤w−1) denote the compressed block of each LBA.

We convert the map-entry Eⱼ into a simplified data structure that contains (1) a fixed-size (e.g., 2 bytes) concatenation pointer, (2) the value of w, which is represented with a fixed number of bytes (e.g., 1 byte), and (3) the size of all the w Cᵢ's, each of which is represented with a fixed number of bytes (e.g., 1 byte).

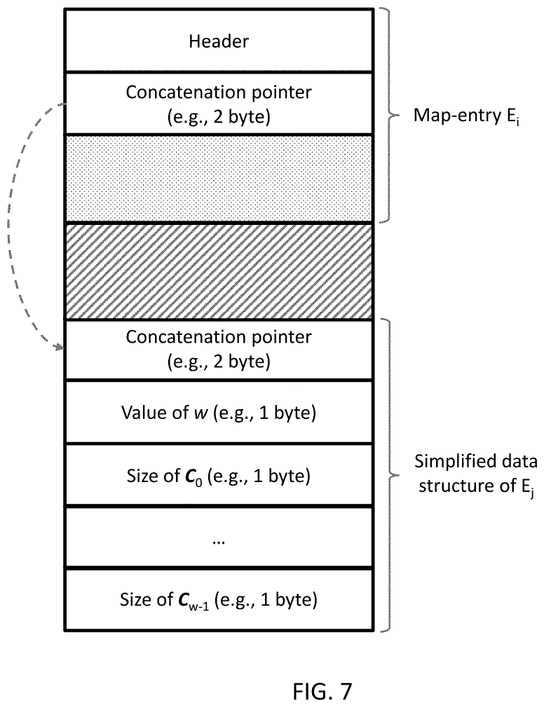

As illustrated in FIG. 7, we append the simplified data structure into the mpage, and accordingly update the “concatenation pointer” in the map-entry Eᵢ so that it records the location of the simplified data structure. In this way, we merge the new map-entry Eⱼ into the existing map-entry Eᵢ, and no longer need to add a new map-entry pointer. In summary, if a new map-entry is contiguous with an existing map-entry, we simply merge this new map-entry into the existing map-entry by appropriately updating its “concatenation pointer”, instead of adding a new map-entry in the mpage.

As discussed above, we always try to append new map-entries into mpages, without modifying existing map-entries, which aims to minimize the operational complexity and hence minimize the CPU overhead.

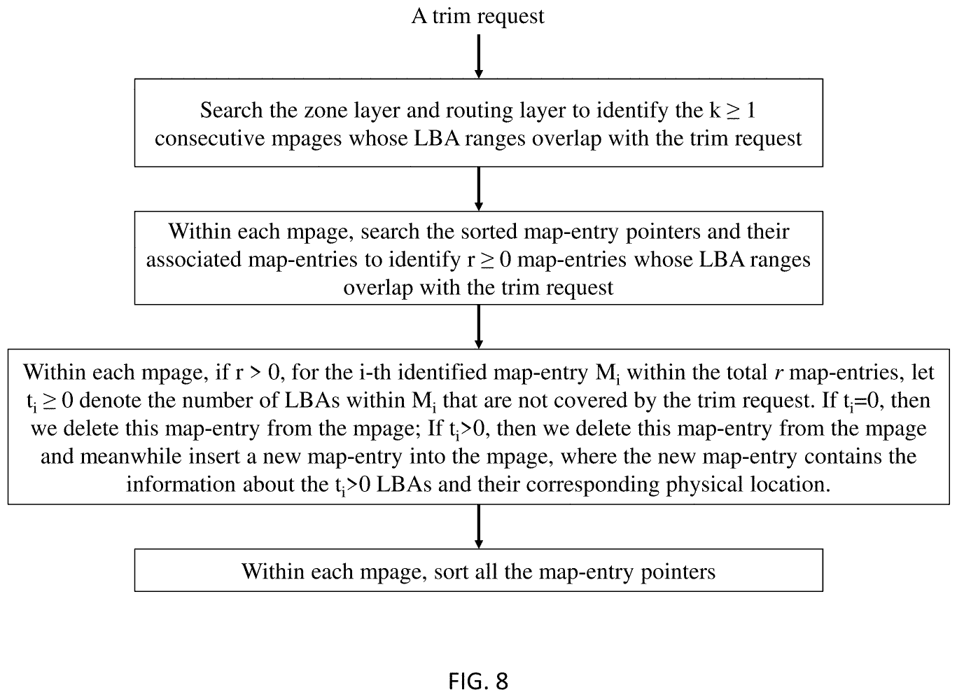

FIG. 8 illustrates the flow diagram of trim logic when using the tiered address map 38. We note that a trim request aims to mark the data at one or multiple contiguous LBAs as invalid. Let L₀ denote the leading LBA of the trim request, and let m denote the number of contiguous LBAs in the trim request (i.e., the trim request covers the LBAs {L₀, L₀+1, L₀+2, . . . , L₀+m−1}). Upon receiving the trim request, storage devices first search the zone layer and routing layer to identify the k≥1 consecutive mpages whose LBA ranges overlap with the trim request. For each mpage within the k consecutive mpages, we perform the following operations:
1. Search the sorted map-entry pointers and their associated map-entries to identify r≥0 map-entries whose LBA ranges overlap with the trim request.
2. If r>0, let {M₁, M₂, . . . , Mᵣ} denote these r map-entries. For each Mᵢ, let tᵢ≥0 denote the number of LBAs within Mᵢ that are not covered by the trim request.
   a. If tᵢ=0, then we delete this map-entry from the mpage. To reduce the operational complexity, we only remove its map-entry pointer, and rely on intra-mpage garbage collection (to be discussed later) to reclaim the space occupied by the deleted map-entry within the mpage.
   b. If tᵢ>0, then we delete this map-entry from the mpage and meanwhile insert a new map-entry into the mpage. The new map-entry contains the information about the tᵢ>0 LBAs and their corresponding physical location.
3. Sort the map-entry pointers in the mpage.
   When an mpage becomes almost full and contains invalid map-entries that have been deleted, we will carry out background garbage collection to reclaim the memory space occupied by those deleted map-entries within the mpage.

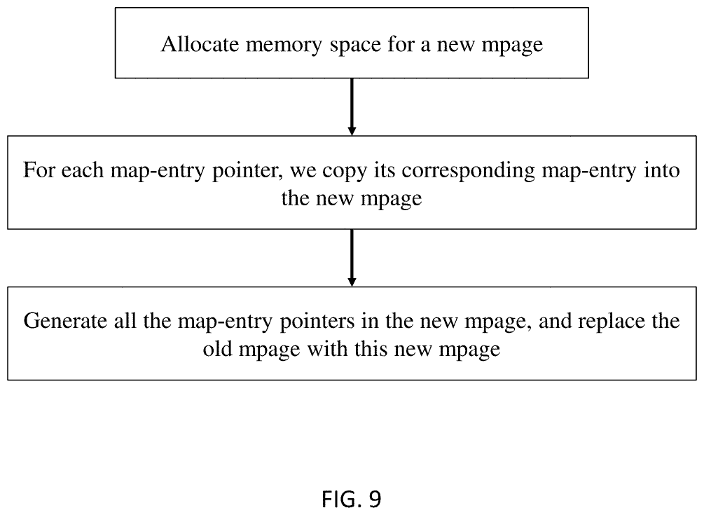

FIG. 9 illustrates the flow diagram of mpage garbage collection: Let v denote the number of map-entry pointers in the mpage. We allocate memory space for a new mpage, and for each map-entry pointer, we copy its corresponding map-entry into the new mpage. Since we already removed the map-entry pointers of all the invalid map-entries, we will not copy all the invalid map-entries into the new mpage. Finally, we generate all the map-entry pointers in the new mpage, and replace the old mpage with this new mpage to finish the garbage collection process for the mpage.

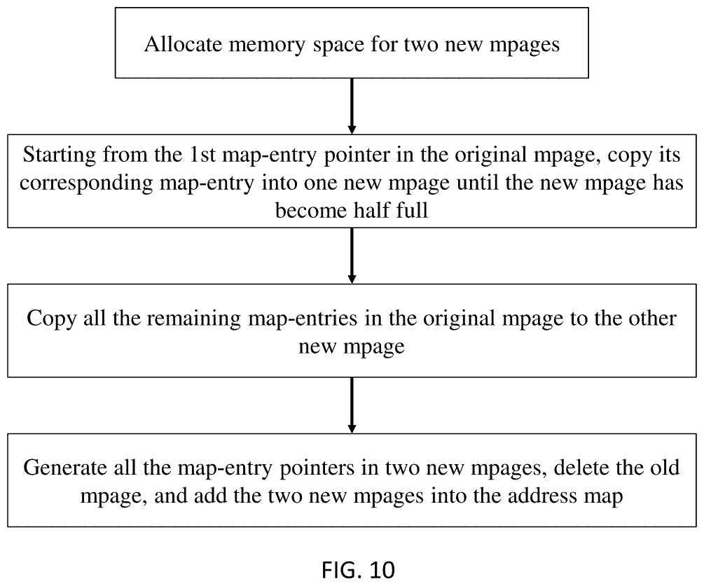

When an mpage becomes almost full and does not contain invalid map-entries, we will split this mpage into two new mpages. FIG. 10 illustrates the flow diagram of an mpage split: We allocate memory space for two new mpages. Recall that all the map-entry pointers are sorted in one mpage. Starting from the 1^{st} map-entry pointer in the original mpage, we copy its corresponding map-entry into one new mpage until the new mpage has become half full, then we copy all the remaining map-entries in the original mpage to the other new mpage. Finally, we generate all the map-entry pointers in two new mpages, delete the old mpage, and add the two new mpages into the address map.

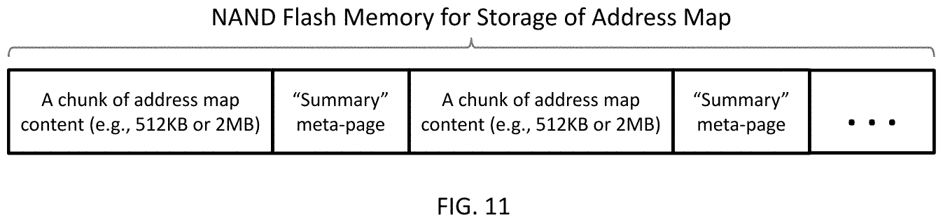

During the runtime, the three-layer address map entirely resides in low-latency memory (e.g., DRAM) that however may be volatile in nature. Therefore, the three-layer address map must be periodically persisted to NAND flash memory. In order to reduce the overhead, we only write modified content in the address map (e.g., modified mpages, modified routing nodes, and/or modified zones) to NAND flash memory, during which all the cross-content pointers (e.g., a pointer in a routing node that points to an mapge) will be accordingly updated to reflect the physical location in NAND flash memory. In the case of graceful shutdown, all the modified content in the address map can be safely written to NAND flash memory. As a result, storage devices can easily reconstruct the three-layer address map in low-latency memory by reading the persisted address map from NAND flash memory. However, in the case of sudden power failure, storage devices may not be able to safely write all the modified content of the address map to NAND flash memory. As a result, during system recovery, storage devices have to scan/read more data from NAND flash memory in order to correctly reconstruct the entire three-layer address map. In order to reduce the map reconstruction latency, this invention presents a method: When storage devices write modified content of the address map to NAND flash memory, every time after a certain chunk of content (e.g., 512 KB or 1 MB) have been written to NAND flash memory, storage devices append a “summary” meta-page to NAND flash memory, as illustrated in FIG. 11. The “summary” meta-page contains the meta information about the content that have been written since last “summary” meta-page.

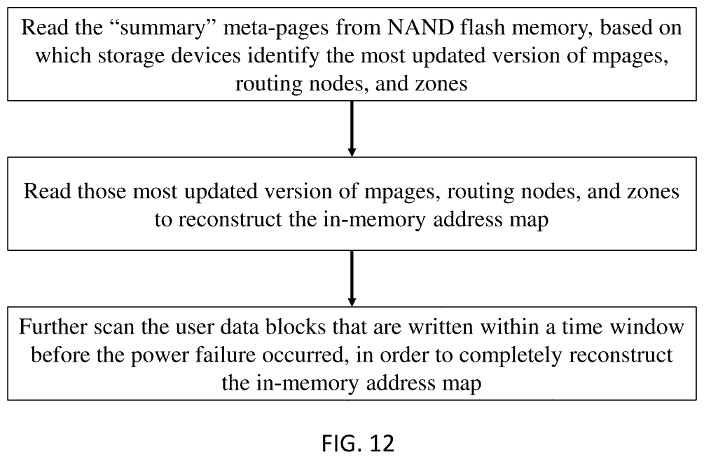

FIG. 12 illustrates the flow diagram a backup system 34 when storage device 14 reconstructs the in-memory address map after power failure. The system first reads the “summary” meta-pages from NAND flash memory, based on which storage devices identify the most updated version of mpages, routing nodes, and zones. Accordingly storage devices read those most updated version of mpages, routing nodes, and zones to reconstruct the in-memory address map. Meanwhile, since some modified mpages, routing nodes, and/or zones may not be written to NAND flash memory during power failure, storage devices will further scan the user data blocks that are written within a time window before the power failure occurred, in order to completely reconstruct the in-memory address map.

It is understood that aspects of the present disclosure may be implemented in any manner, e.g., as a software program, or an integrated circuit board or a controller card that includes a processing core, I/O and processing logic. Aspects may be implemented in hardware or software, or a combination thereof. For example, aspects of the processing logic may be implemented using field programmable gate arrays (FPGAs), ASIC devices, or other hardware-oriented system.

Aspects may be implemented with a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, etc. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by hardware and/or computer readable program instructions.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the present disclosure has been presented for purposes of illustration and description. It is not intended to be exhaustive or to limit the concepts disclosed herein to the precise form disclosed, and obviously, many modifications and variations are possible. Such modifications and variations that may be apparent to an individual in the art are included within the scope of the present disclosure as defined by the accompanying claims.

1. A solid state storage device, comprising:
a compression system that compresses and decompresses data stored in the storage device; and
a controller that utilizes a three tiered logical block address (LBA)/physical block address (PBA) map to map between logical storage and physical storage, wherein the LBA/PBA map includes:
a zone layer having a set of zones that expose an LBA address space of the storage device, wherein each zone spans a contiguous region of LBA addresses;
a routing layer having a set of trees, wherein each tree is indexed by an LBA address and includes a root node and a set of leaf nodes, wherein each root node is associated with a zone from the zone layer, and each leaf node includes a pointer; and
an mpage layer that includes a set of mpages, each mpage pointed to by a pointer from the routing layer, wherein each mpage contains LBA/PBA mapping information for LBAs within a contiguous range of LBAs.

2. The storage device of claim 1, wherein each mpage includes:
a header that determines an LBA range covered by an associated mpage,
map entries that provide the physical location of at least one contiguous LBA; and
map entry pointers, each pointing to a map entry and leading LBA of the contiguous LBA.

3. The storage device of claim 2, wherein each map entry includes a physical location of a PBA and an offset inside the PBA that defines a location of a compressed block of data.

4. The storage device of claim 3, wherein each map entry further includes a size of the compressed block of data and value indicating a number of LBAs covered by the map entry.

5. The storage device of claim 4, further comprising read logic for servicing a read request from a host, the read logic being implemented by a method that includes:
searching the zone layer and routing layer to identify a set of consecutive mpages whose LBA ranges overlap the read request;
identifying a set of map entries from the identified mpages whose LBA ranges overlap with the read request;
identifying a physical location of each compressed data block belonging to the read request with in each map entry;
obtaining a set of physical locations that hold all the compressed blocks of the read request;
fetching and decompressing the compressed blocks.

6. The storage device of claim 4, further comprising write logic for servicing a write request from a host, the write logic being implemented by a method that includes:
searching the zone layer and routing layer to identify a set of consecutive mpages whose LBA ranges overlap the write request;
identifying a set of map entries from the identified mpages whose LBA ranges overlap with the write request;
deleting a map entry pointer from the mpage if the number of LBAs not covered by the write request is 0 for each map entry;
deleting a map entry from the mpage and insert a new map entry into each mpage if the number of LBAs not covered by the write request is greater than 0;
generating a new map entry for each mpage corresponding to the write request and insert the map entry into the mapge; and
sorting all map-entry pointers within each mpage.

7. The storage device of claim 4, further comprising trim logic for servicing a trim request from a host, the time logic being implemented by a method that includes:
searching the zone layer and routing layer to identify a set of consecutive mpages whose LBA ranges overlap the trim request;
identifying a set of map entries from the identified mpages whose LBA ranges overlap with the trim request;
deleting a map entry pointer from the mpage if the number of LBAs not covered by the write request is 0 for each map entry;
deleting a map entry from the mpage and insert a new map entry into each mpage if the number of LBAs not covered by the trim request is greater than 0;
generating a new map entry for each mpage corresponding to the trim request and insert the map entry into the mapge; and
sorting all map-entry pointers within each mpage.

8. The storage device of claim 4, further comprising garbage collection implemented by a method that includes:
allocating memory space for a new mpage;
for each map entry pointer, copying a corresponding map entry into a new mpage; and
generating all the map entry pointers in the new mpage and replace the old mapge with the new mpage.

9. The storage device of claim 4, further comprising splitting logic implemented by a method that includes:
allocating memory space for a new mpage;
starting from a first map entry pointer in an original mpage, copy a corresponding map entry into a first new mpage until the new mpage has become half full;
copying all the remaining map entries in the original mpage to a second new mpage; and
generating all the map-entry pointers in two new mpages, delete the original mpage, and add the two new mpages into an address map.

10. The storage device of claim 4, further comprising reconstruction logic implemented by a method that includes:
reading a set of summary meta-pages from flash memory, based on which storage devices identify a most updated version of mpages, routing nodes, and zones;
reading the most updated version of mpages, routing nodes, and zones to reconstruct an in-memory address map; and
further scanning user data blocks that are written within a time window before a failure occurred.

11. A method, implemented on a solid state storage device, for mapping between logic block addresses (LBAs) and physical block addresses (PBAs), comprising:
receiving a request the specifies an LBA;
determining an applicable zone based on the LBA from a set of zones, wherein the set of zones expose an LBA address space of the storage device;
identifying at least one tree from a set of trees having a root node associated with the applicable zone;
traversing the at least one tree to identify a set of leaf nodes based on the LBA, wherein each leaf node points to an mpage; and
determining corresponding PBA information for the LBA by examining mapping information contained in each mpage.

12. The method of claim 11, wherein each mpage includes:
a header that determines an LBA range covered by an associated mpage,
map entries that provide the physical location of at least one contiguous LBA; and
map entry pointers, each pointing to a map entry and leading LBA of the contiguous LBA.

13. The method of claim 12, wherein each map entry includes a physical location of a PBA and an offset inside the PBA that defines a location of a compressed block of data.

14. The method of claim 13, wherein each map entry further includes a size of the compressed block of data and value indicating a number of LBAs covered by the map entry.

15. The method of claim 14, wherein the request comprises a read request from a host, and the method further includes:
identifying a set of consecutive mpages whose LBA ranges overlap the read request;
identifying a set of map entries from the identified mpages whose LBA ranges overlap with the read request;
identifying a physical location of each compressed data block belonging to the read request with in each map entry;
obtaining a set of physical locations that hold all the compressed blocks of the read request; and
fetching and decompressing the compressed blocks.

16. The method of claim 14, wherein the request comprises a write request and the method further includes:
identifying a set of consecutive mpages whose LBA ranges overlap the write request;
identifying a set of map entries from the identified mpages whose LBA ranges overlap with the write request;
deleting a map entry pointer from the mpage if the number of LBAs not covered by the write request is 0 for each map entry;
deleting a map entry from the mpage and insert a new map entry into each mpage if the number of LBAs not covered by the write request is greater than 0;
generating a new map entry for each mpage corresponding to the write request and inserting the map entry into the mapge; and
sorting all map-entry pointers within each mpage.

17. The method of claim 4, wherein the request comprises a trim request from a host, and the method further includes:
identifying a set of consecutive mpages whose LBA ranges overlap the trim request;
identifying a set of map entries from the identified mpages whose LBA ranges overlap with the trim request;
deleting a map entry pointer from the mpage if the number of LBAs not covered by the write request is 0 for each map entry;
deleting a map entry from the mpage and insert a new map entry into each mpage if the number of LBAs not covered by the trim request is greater than 0;
generating a new map entry for each mpage corresponding to the trim request and inserting the map entry into the mapge; and
sorting all map-entry pointers within each mpage.

18. The method of claim 14, further comprising garbage collection implemented by a method that includes:
allocating memory space for a new mpage;
for each map entry pointer, copying a corresponding map entry into a new mpage; and
generating all the map entry pointers in the new mpage and replacing the old mapge with the new mpage.

19. The method of claim 14, further comprising splitting logic implemented by a method that includes:
allocating memory space for a new mpage;
starting from a first map entry pointer in an original mpage, copy a corresponding map entry into a first new mpage until the new mpage has become half full;
copying all the remaining map entries in the original mpage to a second new mpage; and
generating all the map-entry pointers in two new mpages, delete the original mpage, and add the two new mpages into an address map.

20. The method of claim 14, further comprising reconstruction logic implemented by a method that includes:
reading a set of summary meta-pages from flash memory, based on which storage devices identify a most updated version of mpages, routing nodes, and zones;
reading the most updated version of mpages, routing nodes, and zones to reconstruct an in-memory address map; and
further scanning user data blocks that are written within a time window before a failure occurred.
